(19) United States
(12) Patent Application Publication
(10) Pub. No.: US 2002/0077089 A1
(43) Pub. Date: Jun. 20, 2002

(54) Method and apparatus for caller identification during call waiting

(75) Inventor: Juan Carlos Llamas Contreras, Saltillo (MX)

Correspondence Address: Mark V. Muller, Jenkens & Gilchrist, P.C., 3200 Fountain Place, 1445 Ross Avenue, Dallas, TX, 75202-2799, US

(73) Assignee: TELEFONAKTIEBOLAGET L M ERICSSON (publ)

(21) Appl. No.: 09/738,482

(22) Filed: Dec. 15, 2000

(51) Int. Cl. H04M 3/42

(52) U.S. Cl. 455/415; 379/215.01; 455/414; 455/567

(57) ABSTRACT

A called party is engaged in a first communication with a third party. A calling party then makes a call to the called party while the first communication is ongoing and a call waiting indication is provided to the calling party. Responsive thereto, an identifying signal is selected by the calling party and sent to the called party to announce that the calling party is waiting. The identifying signal may be a tone, sound, or voice message. The called party may respond to the identifying signal by taking the call, dropping the call, or diverting the calling party to an alternative destination, such as voice mail or some call forwarding destination.

### BACKGROUND OF THE INVENTION

1. Technical Field

This invention relates generally to telephone subscriber services. More particularly, the invention relates to a method and apparatus used to identify a calling party to a called party engaged in conversation with a third party, typically involving call waiting services.

2. History of Related Art

Call waiting services are commercially available in many parts of the world. Typically, the service provides an audible tone to a subscriber which indicates that another party is calling them at the same time they are engaged in a conversation with a third party. When making use of the call waiting service, or variants thereof (e.g., call waiting deluxe, call identity on call waiting, call waiting originating, etc.), a called party actively engaged in conversation with a third party is able to place the third party on hold and establish an active connection to the calling party by depressing the switch hook or “flash” button momentarily. Depressing the switch hook or flash button a second time allows reconnection with the third party, and places the calling party on hold. The subscriber (called party) is able to switch between the third party and calling party as many times as needed during the typical call waiting scenario. If one of the parties actively connected to the subscriber disconnects or hangs up, the party on hold, or inactive party, is in turn actively connected to the subscriber.

If the called party does not subscribe to a service which provides calling party identification during call waiting, then the subscriber (called party) will not know the identity of a calling party unless the active connection is swapped. That is, unless the called party places the third party on hold, the identity of the calling party cannot be determined. This may present a problem, as the called party may not need to take the call from the calling party, or may not even desire to speak with the calling party.

Thus, it would be useful to provide a method and/or apparatus to identify a calling party to a called party engaged in conversation with a third party in lieu of typical caller identification equipment and services. Further, such an apparatus or method would be particularly useful if identification could be accomplished repeatedly, and with selectable variation, so as to uniquely identify the calling party to the called party subscriber.

### SUMMARY OF THE INVENTION

The invention includes a method of identifying a calling party to a called party subscriber at the same time the called party is engaged in communication with a third party. The subscriber is associated with a telephone number and a call waiting service having an activated state. The method includes the steps of receiving an identifying signal selected by the calling party and sending the identifying signal selected by the calling party to the called party while the called party and the third party are engaged in conversation. The identifying signal may be a series of tones or other sounds selected by the calling party (known as a “knock”), which are either passed on directly to the called party, or recorded and sent on to the called party.

Responsive to the knock, the method allows the called party to identify the calling party, to place the third party on hold, and to actively communicate with the calling party, or to divert the calling party to an alternate destination, such as a call forwarding telephone number, or a voice mail system. The third party may also send a knock to the called party after being placed on hold, if desired.

The invention also includes an apparatus capable of identifying a calling party to a called party engaged in conversation with a third party, including a telephone for selecting the identifying signal by the calling party, and a node for sending the identifying signal selected by the calling party to the called party. The node may be a Mobile Switching Center (MSC).

### BRIEF DESCRIPTION OF THE DRAWINGS

A more complete understanding of the structure and operation of the present invention may be had by reference to the following detailed description when taken in conjunction with the accompanying drawings, wherein:

FIG. 1 is a generic network operational diagram illustrating an embodiment of the method of the present invention;

FIG. 2 is a cellular network operational diagram illustrating an embodiment of the method of the present invention; and

FIG. 3 is a block diagram of a cellular telephone and node which embody the apparatus of the present invention.

### DETAILED DESCRIPTION OF PRESENTLY PREFERRED EXEMPLARY EMBODIMENTS

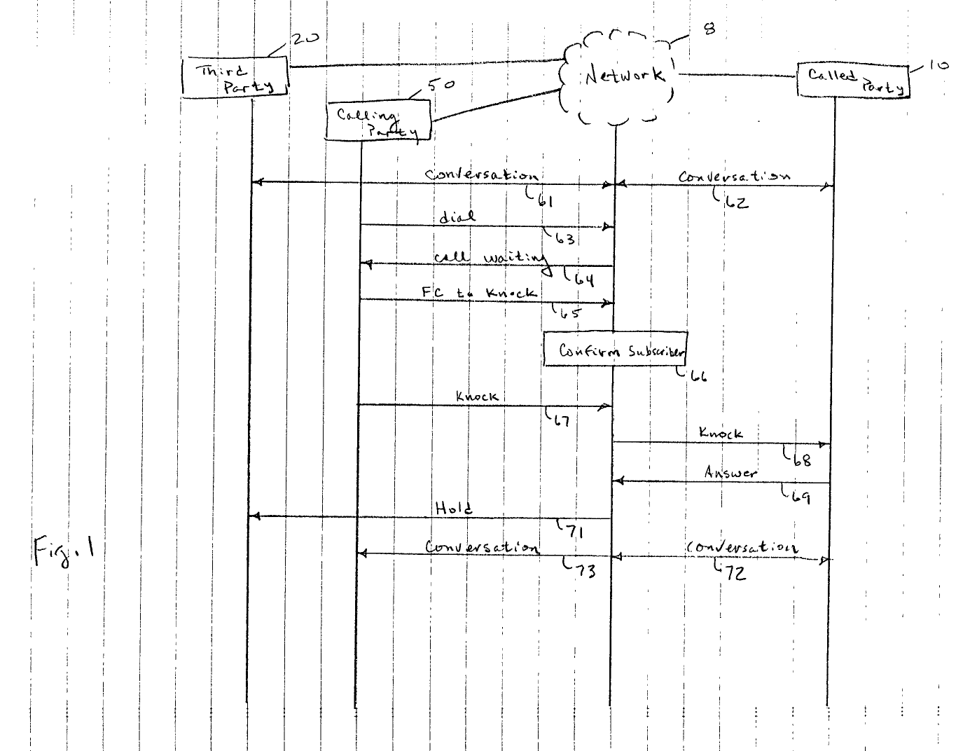

FIG. 1 illustrates a generic network operational diagram, illustrating the method of the present invention. In this case, the network 8 controls connections between a called party 10 in conversation with a third party 20, and a calling party 50, attempting to call the called party 10. Here the parties 10, 20 are engaged in conversation 61, 62 via the network 8, and the calling party 50 attempts to dial 63 the called party 10. Since the parties 10, 20 are already engaged in conversation 61, 62, the calling party 50 receives some kind of an indication 64, typically a call waiting tone, which tells the calling party 50 that the called party 10 is engaged in conversation with some unknown party.

The calling party 50 may then elect to take advantage of the method of the present invention and enter a feature code 65, which is sent to the network 8 to initiate sending some kind of identifying sound, tone, or code (i.e., a “knock” signal) to the called party 10 which indicates that the particular calling party 50 is attempting to call the called party 10. The network 8 confirms that the calling party subscriber 50 is entitled to “knock” during an ongoing conversation between the called party 10 and some unknown party in step 66, and, after confirmation, the actual “knock” signal 67 is received by the network 8 from the calling party 50. The “knock” (tone, sound, signal, or recorded voice message) 67 may be an automatically-generated response to step 66, or it may be selected by the calling party 50 to uniquely identify the calling party 50 to the called party 10. The “knock” is then passed on from the network 8 to the called party 10 in step 68.

The called party 10, after hearing the characteristic “knock” 67 of the calling party 50, may elect to answer the calling party 50 in step 69. If the call is answered by the called party 10, then the third party 20 is placed on hold in step 71 and the called party 10 and calling party 50 may engage in conversation 72, 73 via the network 8.

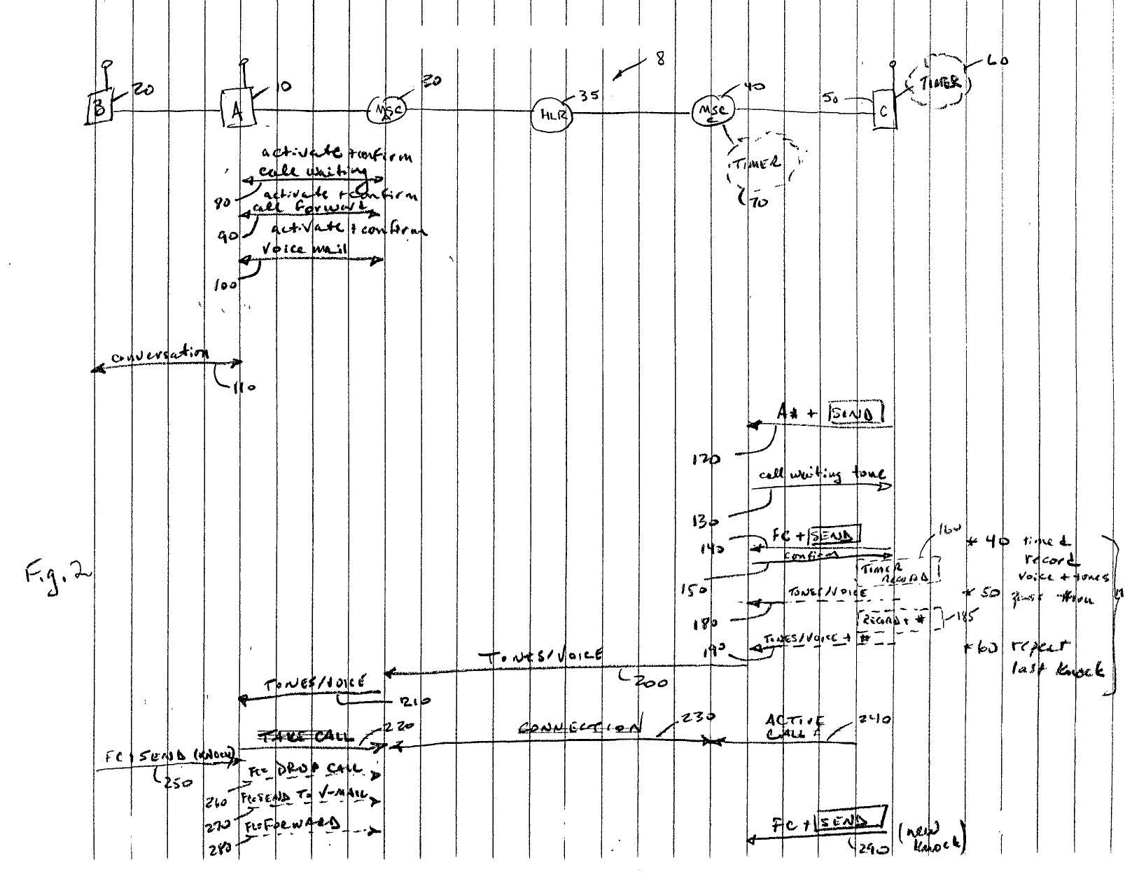

Referring now to FIG. 2, a network operational diagram of the method of the present invention, along with several components of a conventional cellular telecommunications network 8, can be seen. In this more detailed scenario, a mobile station or other telecommunications device operated by a called party 10 is in conversation 110 with a third party also operating a mobile station or other telecommunications device 20. Prior to engaging in conversation 110, the called party 10 has activated and confirmed operation of a call waiting service in step 80 with a Mobile Switching Center (MSC) 30, or some other network node, such as a Home Location Register (HLR) 35. Optionally, the called party 10 may have activated and then confirmed a call forwarding service 90 and/or a voice mail service 100 with the MSC 30.

After the call waiting service has been placed in the activated state in step 80, and the parties 10, 20, are engaged in conversation, a calling party 50 dials the telephone number of the called party 10, attempting to engage the called party 10 in conversation. Thus, the called party telephone number (i.e., the A-number) is dialed by the calling party 50 in step 120. Since the call waiting service 80 has been placed in the activated state, the calling party 50 receives a call waiting tone, or other indication that the called party 10 is engaged in conversation 110 with the third party 20. This occurs in step 130.

By way of example, and not of limitation, the calling party 50 may then be able to dial a Feature Code (e.g., *40), which is sent to the local MSC 40 (this example assumes that the calling party 50 is making use of a mobile telephone, and not some other telecommunications device, which could also be used to implement the method of the present invention). Since the called party 10 has activated the call waiting service, and the calling party 50 has dialed the Feature Code to initiate sending a particular identification message to the called party associated with the A-number, the local MSC 40 confirms receipt of the Feature Code request in step 150. Thus, the calling party 50 receives an indication that the called party 10 is engaged in communication with the third party 20, and that the call waiting service 80 has been placed in the activated state, prompting entry of a “knock” by the calling party 50. Thereafter, a timer 60, 70, resident in the calling party 50 telecommunication device, or the local MSC 40, respectively, may be used to allow entry of a series of tones using the keypad of the calling party 50 telecommunications device in step 160. Alternatively, instead of using a timed recording period, a series of tones may be entered followed by a terminating character, such as the “# sign”, which is recognized by the local MSC 40 as terminating the entry string.

In addition to recording tones, the voice of the calling party 50 or some other series of sounds can be recorded by the calling party 50. A timer 60, 70 can be used to count down the recording time, which is limited to the timeout period, and a unique series of tones, voice, or other sound can be recorded by the calling party 50 in step 160. Thus, the method may include the step of starting a timer 60, 70 having a timeout period and recording a sound during the timeout period.

The recorded tones, voice, or other sounds are then sent on to the local MSC 40 in step 180, to be passed on to the called party 10. First, the recorded sounds are sent to the MSC 30 in step 200, and then the recorded sounds are sent from the MSC 30 to the called party 10 in step 210. Optionally, additional recordings can be made in step 185 if the original Feature Code (e.g., *40) is entered by the calling party 50. Thus, a new recording can be made in step 185, and the recorded sounds can be sent on to the local MSC 40 in step 190 for transmission to the called party 10 via steps 200 and 210. Optionally, the recording made during step 160 can be re-sent to the called party 10 by entering another feature code (e.g. *60) by the calling party 50.

The process of identifying the calling party 50 to the called party 10 by using a distinctive sound or series of sounds is defined herein as “knocking”. Typically, the “knock” is recorded in step 160 for sending on to the called party 10 in steps 180, 190, 200, 210. As mentioned above, the same “knock” can be repeated by entering the appropriate Feature Code, or a new “knock” can be recorded in step 185 for sending on to the called party 10 in steps 190, 200, and 210. Alternatively, instead of recording the “knock” in steps 160, 185, another Feature Code (e.g. *50) can be used to directly pass through tones or other sounds from the calling party to the called party 10. Such options are illustrated in FIG. 2 at step 170. To pass through tones or other sounds (the “knock”) from the calling party 50 to the called party 10, a conventional telephone (i.e., analog telephone) is typically required. Otherwise, a digital telephone, or some other device having a memory, such as a node or switch, is needed to record the tones and/or sounds to send on to the called party 10.

Thus, the identifying signal 67 selected by the calling party may be sent repeatedly to the called party 10, or a different identifying signal 67 may be sent as selected by the calling party 50. The identifying signal 67 may be selected by entering a predetermined feature code to enable sending the signal, selecting the signal itself, and entering the identifying signal 67. If the calling party 50 desires to record a series of tones or other sounds for sending to the called party 10, a countdown timer 60, 70 having a time-out period may be started, and the tones/sounds may be recorded during the timeout period.

When the identifying signal 67 is recorded by the calling party, the recording may be terminated by having the calling party enter a terminating character or by timing out the operation. As mentioned above, the same identifying signal 67 can be repeatedly sent to the called party, or a different signal (i.e., an “other” identifying signal) can be selected by the calling party for sending on to the called party. The selection of a different identifying signal may be made by entering a different, predetermined feature code. In any event, the identifying signal 67 is typically only audible to the called party, and not to the third party.

After receiving the “knock”, the called party 10 has the option of taking the call in step 220, wherein a trunk connection 230 is established between the MSC 30 and the local MSC 40, and an active call is established between the calling party 50 and the called party 10 at step 240. More or less simultaneously, the third party 20 is placed on hold.

Alternatively, instead of taking the call at step 220, the called party 10 may dial a predetermined Feature Code in step 260 to drop the call with the calling party 50. This might happen in a situation where the called party 10 does not desire to speak to the calling party 50, and does not wish to record a message. The called party 10 may also elect, using a predetermined Feature Code, to divert the calling party 50 to an alternative destination, such as to voice mail in step 270, or to some call forwarding destination in step 280. The handling of the attempted call from the calling party 50 may thus take several paths, according to the desire of the called party 10.

If the called party 10 decides to take the call from the calling party 50 in step 220, which results in establishing an active call connection between them in steps 230 and 240, the third party 20 may in turn decide to send its own identifying “knock” to the called party 10 in step 250. This is accomplished in much the same way as shown for the calling party 50 in steps 140-180. The called party 10 may then elect to take the call from the third party 20, drop the call with the third party 20, or divert the call from the third party 20 to an alternative destination, such as voice mail or a call forwarding number. The process of “knocking” can be repeated indefinitely by the third party 20 in step 250, and the calling party 50 in step 290, each time one or the other is placed on hold. Typically, only the “knocking” party and the called party 10 will be able to hear when a “knock” is presented to the called party 10. Alternatively, all parties 10, 20, 50 may be allowed to hear any particular “knock” when it is presented to the called party 10. Also, if the third party 20 is placed on hold and so desires, the third party 20 may also send a selected identifying signal or knock to the called party 10 while the called party is engaged in conversation with the calling party 50.

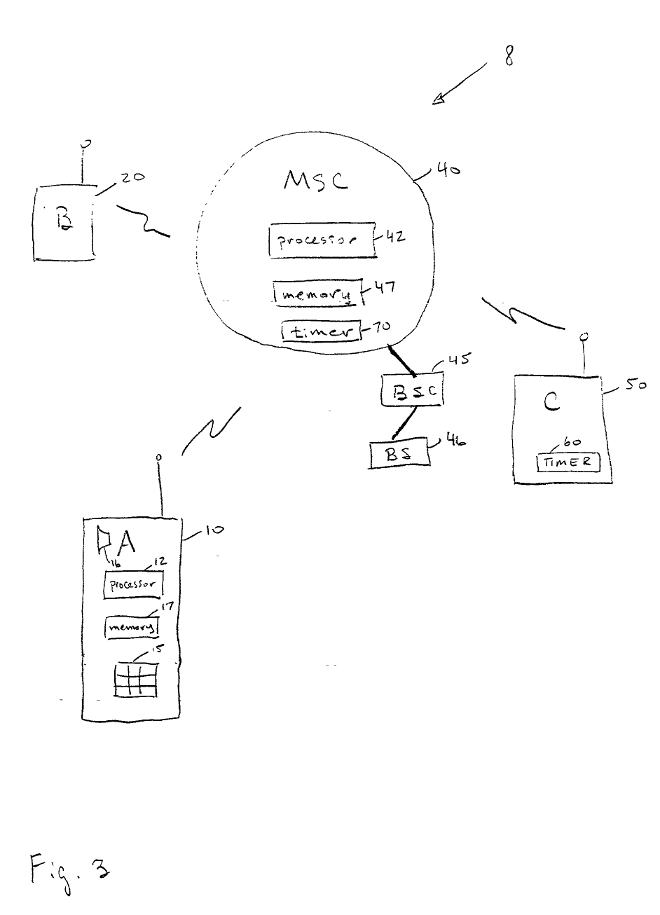

Turning now to FIG. 3, a schematic block diagram of a telecommunications network 8 including an apparatus capable of identifying a calling party to a called party engaged in conversation with a third party can be seen. In this case, the apparatus may be embodied in a telecommunications device 10, such as a mobile telephone, a conventional analog telephone, or some other telecommunications device, and a node 40. Typically, the telephone 10 has a processor 12 and a memory 17, and provides a means for placing the call waiting service used by the subscriber operating the telephone 10 into an activated state, dialing the telephone number (A-number) of the called party, receiving an indication that the called party is engaged in communication with a third party (and that the call waiting service has been placed in the activated state), selecting an identifying signal, and sending the identifying signal selected by the calling party to the called party. Typically, a series of tones is entered using the keypad 15 to form the “knock”. However, the calling party may also record a sound or series of sounds using the microphone 16 in the telephone 10.

In FIG. 3, the telephone 10 is shown communicating with a base station 46 controlled by a base station controller 45, which is in turn connected to a node 40 such as a Mobile Switching Center. The telephone 20 is operated by a third party, typically engaged in communication with the called party, operating the telephone 10. A telephone 50 is typically operated by a calling party, and communicates, directly or indirectly, with the node 40. As shown in FIG. 3, timers 60, 70 may reside in the telephone 50 operated by the calling party, and the node 40, respectively.

As noted above, the apparatus of the present invention includes the node 40, which provides a means for placing the call waiting service into an activated state on behalf of the called party, dialing the telephone number of the called party as directed by the calling party, receiving an indication that the called party is engaged in communication with the third party, and sending the identifying signal selected by the calling party to the called party. The node for implementing these functions includes a processor 42 and a memory 47. These devices 10 and 40 may also make use of the processors 12, 42 and/or the memories 17, 47 to implement the function of diverting the calling party to an alternative destination selected by the calling party.

The invention can be implemented within the cellular telephone network system, or within the Public-Switched Telephone Network (PSTN), as an extension of the call waiting services presently available. The invention can be implemented using a standard dial telephone, mobile cellular telephone, or other readily available Consumer Premise Equipment (CPE).

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. A method for identifying a calling party to a called party when the called party is engaged in communication with a third party, comprising the steps of:
receiving an identifying signal selected by the calling party and sending the identifying signal to the called party while the called party is engaged in conversation with the third party.

2. The method of claim 1, including the steps of:
placing the third party on hold; and
engaging the calling party in communication with the called party.

3. The method of claim 2, including the step of sending an other identifying signal selected by the third party to the called party.

4. The method of claim 1, including the step of diverting the calling party to a destination selected by the called party.

5. The method of claim 4, wherein the destination is a call forwarding telephone number.

6. The method of claim 4, wherein the destination is a voice mail system.

7. The method of claim 1, including the step of repeating the step of sending the identifying signal to the called party.

8. The method of claim 1, wherein the step of sending the identifying signal to the called party includes the step of entering an other predetermined feature code.

9. The method of claim 1, wherein the identifying signal is a recorded sound.

10. The method of claim 1, wherein the identifying signal is a series of tones.

11. The method of claim 1, wherein the step of sending the identifying signal to the called party includes the steps of:
entering a predetermined feature code to enable sending the identifying signal to the called party;
selecting the identifying signal; and
entering the identifying signal.

12. The method of claim 11, wherein the step of entering the identifying signal includes the steps of:
starting a timer having a timeout period; and
entering a series of tones during the timeout period.

13. The method of claim 11, wherein the step of entering the identifying signal includes the steps of:
starting a timer having a timeout period; and
recording a sound during the timeout period.

14. The method of claim 11, wherein the step of entering the identifying signal includes the step of entering a series of tones.

15. The method of claim 11, wherein the step of entering the identifying signal includes the step of recording a sound.

16. The method of claim 11, wherein the step of entering the identifying signal includes the step of entering a terminating character.

17. The method of claim 1, wherein the identifying signal is audible to the called party, and inaudible to the third party.

18. An apparatus for identifying a calling party to a called party when the called party is engaged in communication with a third party, comprising:
a telephone for selecting an identifying signal; and
a node for sending the selected identifying signal to the called party when the called party is engaged in conversation with the third party.

19. The apparatus of claim 18, wherein the node is used for placing the third party on hold and for engaging the calling party in conversation with the called party.

20. The apparatus of claim 18, wherein the node is used for diverting the calling party to a destination selected by the called party.
